(19) United States
(12) Patent Application Publication
(10) Pub. No.: US 2006/0158533 A1
(43) Pub. Date: Jul. 20, 2006

(54) System for storing RFID information for an image in a data file

(75) Inventors: Deepali Apurva Brahmbhatt, Mountain View, CA (US); John Albert Toebes, Cary, NC (US)

Correspondence Address: SIERRA PATENT GROUP, LTD., 1657 Hwy 395, Suite 202, Minden, NV, 89423, US

(73) Assignee: Cisco Technology, Inc.

(21) Appl. No.: 11/036,912

(22) Filed: Jan. 14, 2005

(51) Int. Cl. H04N 5/76; H04Q 5/22

(52) U.S. Cl. 348/231.2; 348/231.3

(57) ABSTRACT

A data file stored in a memory for storing an image with Radio Frequency Identification (RFID) device information. In this data file image data is stored in an image portion of the file. RFID device information for an RFID device that proximate the location shown in the image is then stored in a field in a metadata portion of the file.

### FIELD OF THE INVENTION

This invention relates to a data file for storing a digital image and Radio frequency Identification (RFID) device information in a data file. More particularly, this invention relates to storing image data in an image portion of a file and RFID device information in a meta data portion of the file. Still more particularly, this invention relates to storing the image in an image portion of a file having an EXIF format and storing the RFID information in a miscellaneous field of the meta data portion of the file.

### SUMMARY OF THE PRIOR ART

One new method of tracking objects in a given area is Radio Frequency Identification (RFID). In a RFID system, a RFID device commonly referred to as a RFID tag is affixed to an object. The RFID device then either periodically transmits RF signals giving identification information or transmits the information when an interrogation RF signal is received. A reader then receives the RF signals and can determine the objects in the area from the information received from RFID devices within range of the reader.

As technology has increased the quality of digital images and decreased the cost of digital imaging devices, such as digital cameras, it has become common to monitor a location by capturing images of the area. Thus, there is a need in the art for an ability to relate RFID information received for an area with a digital image of an area to accurately identify objects shown in the image. Preferably, this information could be communicated in one file in an existing format so that the files could be used by existing devices and software.

### SUMMARY OF THE INVENTION

The above and other problems are solved and an advance in the art is made by a data file for storing an image with RFID information in accordance with this invention. One advantage of this invention is a way to monitor the position of a RFID device through the use of digital images. This invention provides a method for conveying information about a RFID device proximate a location shown in an image within a file storing the image. This allows a user of the information an easy and reliable method for passing this information.

In accordance with this invention, a data file has a meta data portion and an image portion. The image portion of the data file stores image data needed to display an image. The meta data portions store data pertaining to properties of the image. In accordance with this invention, information about RFID devices proximate the location shown in the image are stored in the meta data portion of the file. This invention may use miscellaneous fields in a known format such as EXIF to store the RFID information. This allows files in accordance with this invention to be used by existing devices that can read the EXIF format.

### BRIEF DESCRIPTION OF THE DRAWINGS

The above and other features and advantages of this invention are set forth in the following detailed description and the following drawings:

FIG. 1 illustrating a block diagram of data in exemplary embodiment of a data file in accordance with this invention;

FIG. 2 illustrating an RFID information field in an exemplary embodiment of a meta data portion in accordance with this invention;

FIG. 3 illustrating a field for storing RFID information in a field in a meta data portion of a data file having an EXIF format in accordance with this invention;

FIG. 4 illustrating a second exemplary embodiment of a field for storing RFID information in a field in a meta data portion of a data file having an EXIF format in accordance with this invention;

FIG. 5 illustrating a processing system that generates a data file in accordance with this invention;

FIG. 6 illustrating a flow diagram for a method for generating a data file in accordance with this invention; and

FIG. 7 showing a file in EXIF format in accordance with this invention.

### DETAILED DESCRIPTION

This invention relates to a data file for storing information about RFID devices proximate a location shown in image stored in the file. The following exemplary embodiments are meant to enable one skilled in the art to generate and use a data file in accordance with this invention.

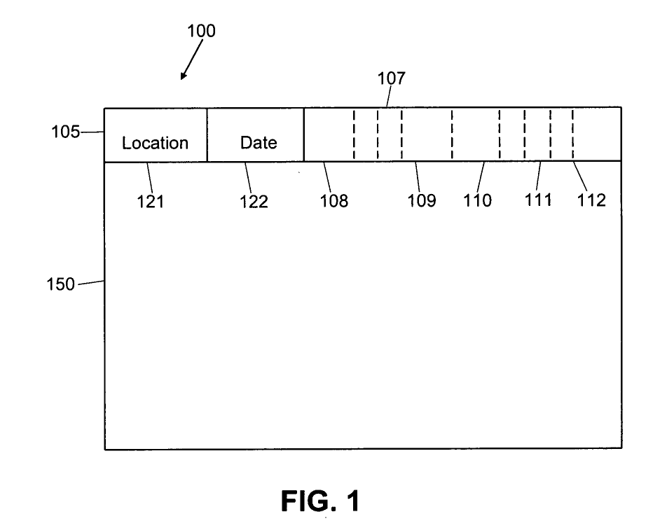

FIG. 1 illustrates a digital file for storing an image with RFID information in accordance with this invention. Data file 100 may be in one of several formats including but not limited to EXIF. Data file 100 includes a meta data portion 105 and an image portion 150. Image portion 150 is the portion of data file 100 that stores information for the image. This information may be stored in any of several formats including JPEG. The exact configuration of that the image data is stored may also depend on the format of data file 110.

Meta data portion 105 stores information relating to the image. Such information may include a location field 121, and a date created field 122. Other information may include the device producing the image, a user creating the image, and time of day. One skilled in the art will recognize any number of fields and the type of information stored may be dictated by the format of the file and the information a user wants to store. In accordance with this invention, meta data portion 105 also includes a RFID field 107 that stores information for each RFID device that is proximate the location shown in the image. The RFID field may include a separate sub-field 108-112 for each RFID device. The information for each RFID device may include an identifier of the RFID device, a location of the RFID device in the image, and/or a Global Positioning System (GPS) location of the device.

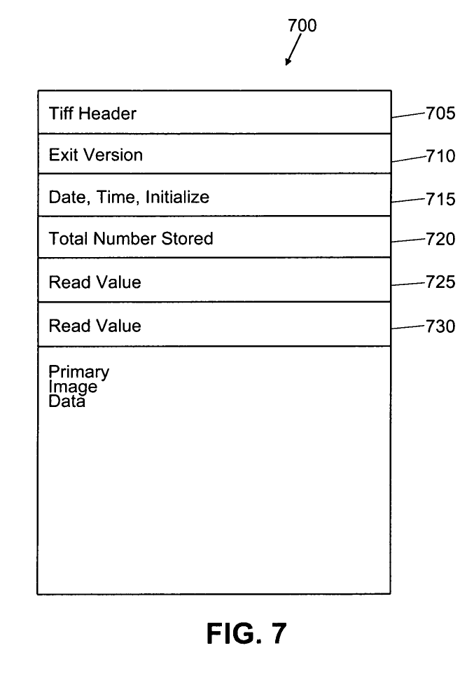

FIG. 7 illustrates a block diagram of the fields in a meta data portion of an image file stored in an EXIF formatted file. Meta data 700 includes a TIFF header 705, EXIF version 710, Date time filed 715, Total number stored field 720, read value 1 field 725, and read value 2 field 730. Tiff header field 705 identifies the image stored in the file. EXIF version field 710 identifies the EXIF version used to format the file. Date, time initialized field 715 stores the date and time the image was created. The total number stored field indicates the total number of images stored in the file. Read value field 725 and 730 store read values for the file.

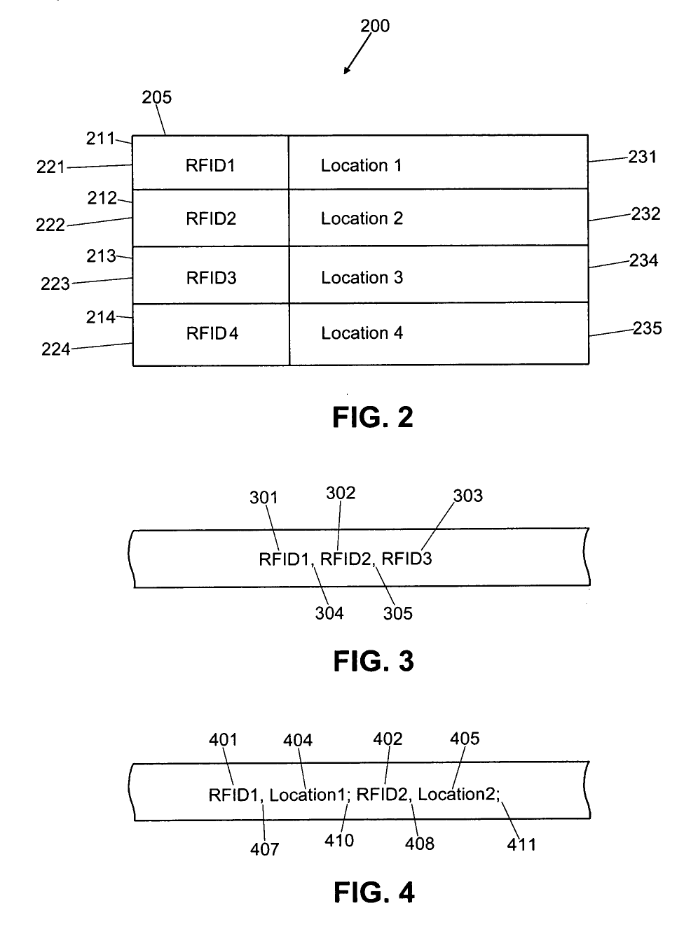

FIG. 2 illustrates an exemplary embodiment of a meta data portion 200 of data that includes RFID device information for an image. Meta data portion 200 includes a field 205 that stores RFID device information for each device proximate a location shown in an image. Each sub-field 211-214 stores information for one RFID device. In some embodiments, each sub-field 211-214 may only store an identifier for each RFID device. However, each sub-field may be partitioned to allow different types of information for the identified RFID device. For example, in this embodiment, each sub-field 211-214 may have a first partition 221-224 that stores an identifier and a second partition that stores location information for the device. The location information may be the location of the device in the image or a GPS coordinate for the device.

FIG. 3 illustrates a miscellaneous field in the meta data of an EXIF format file used to store RFID device information. In this embodiment, only identification data for the RFID device is stored. The identifications 301-303 of each RFID device are stored in Ascii string, each identification is separated by a symbol such as a comma 304-305. One skilled in the art will recognize that other symbols may be used and that other types of formats may be used to represent the RFID device identifiers.

FIG. 4 illustrates a second embodiment in which information other than the identifier of an RFID device is also stored in the field in the meta data of an EXIF formatted file. In this embodiment, the RFID device information includes an identifier and location information. One skilled in the art will recognize other types of information may be stored with the identifier and the information is not limited to location information. For each RFID device, each RFID device identifier 401-403 is separated from location information 404-406 for the device by a first symbol 407-409, such as a comma. The information for each device is then separated by a second symbol 410-412, such as a semi-colon. One skilled art will recognize that types of information may be further sub-divided by using a third and subsequent different symbols.

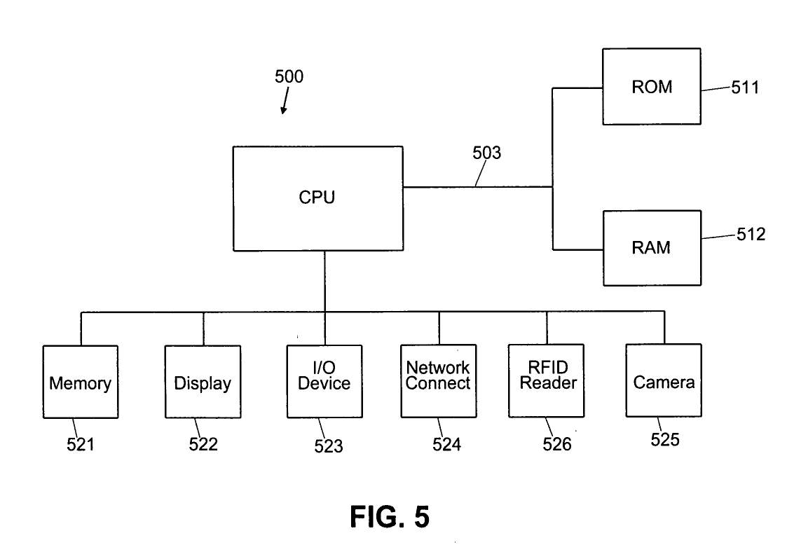

FIG. 5 illustrates an exemplary processing system that generates a data file storing an image with RFID information in accordance with this invention. One skilled in the art will recognize that other configurations of devices may practice this invention. For example, a network which includes a process system, a digital camera, and an RFID reader may generate files in accordance with this invention. FIG. 5 illustrates an exemplary embodiment of a processing system 500. Furthermore, one skilled in the art will recognize that a processing system may be incorporated into other devices such as a digital camera. One skilled in the art will recognize this is for exemplary purposes only and the exact configuration and devices connected to the processing system generating a file in accordance with this invention may vary depending upon the functions that the processing device performs.

Processing system 500 has a Central Processing Unit (CPU) 501. CPU 501 is a processor, microprocessor, or any combination of processors and/or microprocessors that execute instructions stored in memory to perform an application. CPU 501 is connected to a memory bus 503 and Input/Output (I/O) bus 204.

A non-volatile memory such as Read Only Memory (ROM) 511 is connected to CPU 501 via memory bus 503. ROM 511 stores instructions for initialization and other systems command of processing system 500. One skilled in the art will recognize that any memory that cannot be written to by CPU 501 may be used for the functions of ROM 511.

A volatile memory such as Random Access Memory (RAM) 512 is also connected to CPU 501 via memory bus 504. RAM 512 stores instructions for all processes being executed and data operated upon by the executed processes. One skilled in the art will recognize that other types of memories such as DRAM and SRAM may also be used as a volatile memory and that memory caches and other memory devices (not shown) may be connected to memory bus 504.

Peripheral devices including, but not limited to, memory 521, display 522, I/O device 523, network connection device 524, digital camera 525 and RFID reader 526 that are connected to CPU 501 via I/O bus 504. I/O bus 504 carries data between the device and CPU 501. Memory 501 is a device for storing data unto a media. Some examples of memory 521 include read/write compact discs (CDs), and magnetic disk drives. Display 522 is a monitor or display and associated drivers that convert data to a display. I/O device 523 is a keyboard, a pointing device or other device that may be used by a user to input data. Network device 524 is a modem or Ethernet “card” that connects processing system 500 to a network. Digital camera 525 is a device that captures a digital image of a location and is well known in the art. RFID reader 536 is a device that transmits RF signals and receives data from RFID devices in response to the transmitted RF signals.

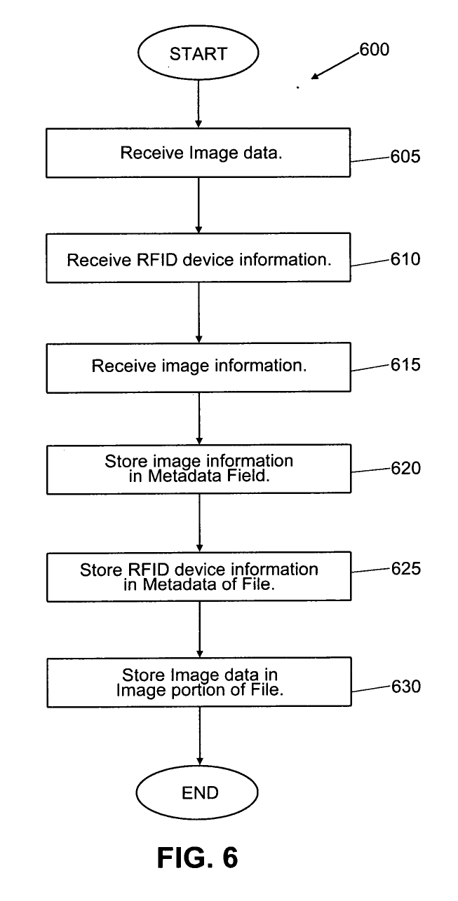

FIG. 6 illustrates a method that is performed by software executed by processing system 500 (FIG. 5) to generate a file for storing an image with RFID device information in accordance with this invention. Process 600 begins in step 605 by receiving image data for an image. This image data may be data of an image captured by a digital camera or other imaging device and transmitted to processing system 500.

In step 610, information for each RFID device proximate the location shown in an image is received. One skilled in the art will recognize that currently there is not a way to limit the RFID device to only those shown in an image. However, the digital file of this invention could be limited to only those RFID devices shown in the image if technology permits. Furthermore, the information for each RFID device proximate the location may be received from an RFID reader. The RFID reader gathering the information by transmitting RF signals and receiving information from each RFID device that receives the RF signals and responds by transmitting RF signals to the RFID reader.

In step 615, image data is stored in the image portion of the data file. In step 625 the information for each RFID device proximate the location shown in the image is stored in the meta data portion of the file. Process 600 then ends in step 630 with the other image information being stored in the meta data portion of the file.

The above is a description of exemplary embodiments of a file for storing an image with RFID information and a process for generating the file. It is foreseen that those skilled in the art can and will design alternative embodiments that infringe on this invention as set forth in claims below either literally or through the Doctrine of Equivalents.

What is claimed is:

1. A data file stored in a memory for storing an image with Radio Frequency Identification (RFID) device information, said file comprising:
an image portion for storing image data;
a meta data portion for storing information relating to said image; and
at least one field in said meta data portion for storing information of at least one RFID device proximate to a location shown in said image.

2. The data file of claim 1 wherein said information of each of said at least one RFID device comprises:
an identifier of said at least one RFID device.

3. The data file of claim 1 wherein said information of each of said at least one RFID device comprises:
a location of said at least one RFID device.

4. The data file of claim 1 wherein said information of each of said at least one RFID device comprises:
a location within said image of said at least one RFID.

5. The data file of claim 1 wherein said data file is stored in an EXIF format.

6. The data file of claim 5 wherein said at least one field in said meta data portion is a meta data field and said information at least one said RFID device is stored in an ASCII string.

7. The data file of claim 6 further comprising:
a first symbol in said ASCII string that separates information for each of said at least one RFID device.

8. The data file of claim 7 wherein said first symbol is a comma.

9. The data file of claim 7 further comprising:
a second symbol in said ASCII string that separates each different type of information in said information for each of said at least one RFID device.

10. The data file of claim 9 wherein said first symbol is a semi-colon.

11. The data file of claim 9 wherein said first symbol is a comma.

12. A method for generating a data file in a memory for storing an image with Radio Frequency Identification (RFID) information comprising:
receiving image data for an image;
receiving information for at least one RFID device proximate a location shown in said image;
storing said image data in an image portion of said data file; and
storing said information for said at least one RFID device in a field in a meta data portion of said data file.

13. The method of claim 12 further comprising:
receiving other image information; and
storing said other image information in said meta data portion of said data file.

14. The method of claim 12 wherein said step of receiving said image data comprises:
capturing an image of a location with an image capturing device.

15. The method of claim 14 wherein said image capturing device is a camera.

16. The method of claim 12 wherein said step of receiving information for said at least one RFID comprises:
transmitting interrogation RF signals; and
receiving response RF signals from each said RFID device that receives said interrogation signals wherein said response RF signals include an identifier of an RFID device transmitting said response RF signals.

17. The method of claim 12 wherein said data file is in an EXIF format and said step of storing said information for said at least one RFID device comprises:
generating an ASCII string that includes information for each of said at least one RFID device; and
storing said ASCII string in said meta data portion of said file.

18. The method of claim 17 wherein said step of generating said ASCII string comprising:
separating information for each of said at least one RFID device by a symbol.

19. The method of claim 18 wherein said symbol is a comma.

20. The method of claim 18 wherein said step of generating said ASCII string further comprises:
separating each different type of information for each of said at least one RFID device by a second symbol.

21. A system for generating a data file in a memory for storing an image with Radio Frequency Identification (RFID) information comprising:
means for receiving image data for an image;
means for receiving information for at least one RFID device proximate a location shown in said image;
means for storing said image data in an image portion of said data file; and
means for storing said information for said at least one RFID device in a field in a meta data portion of said data file.

22. The apparatus of claim 21 further comprising:
means for receiving other image information; and
means for storing said other image information in said meta data portion of said data file.

23. The apparatus of claim 21 wherein said means for receiving said image data comprises:
means for capturing an image of a location with an image capturing device.

24. The apparatus of claim 23 wherein said image capturing device is a camera.

25. The apparatus of claim 21 wherein said means for receiving information for said at least one RFID comprises:
means for transmitting interrogation RF signals; and
means for receiving response RF signals from each said RFID device that receives said interrogation signals wherein said response RF signals include an identifier of an RFID device transmitting said response RF signals.

26. The apparatus of claim 21 wherein said data file is in an EXIF format and said means for storing said information for said at least one RFID device comprises:
means for generating an ASCII string that includes information for each of said at least one RFID devices; and
means for storing said ASCII string in said meta data portion of said file.

27. The apparatus of claim 26 wherein said means for generating said ASCII string comprising:
means for separating information for each said at least one RFID device by a symbol.

28. The apparatus of claim 27 wherein said symbol is a comma.

29. The apparatus of claim 27 wherein said means for generating said ASCII string further comprises:
means for separating each different type of information for each of said at least one RFID device by a second symbol.
